(19) United States
(12) Patent Application Publication
(10) Pub. No.: US 2011/0000209 A1
(43) Pub. Date: Jan. 6, 2011

(54) TURBOCHARGER COMPRISING AN ACTUATOR FOR OPENING AND CLOSING A WASTEGATE DUCT

(75) Inventors: Ralf Boening, Reiffelbach (DE); Hartmut Claus, Gruenstadt (DE); Dirk Frankenstein, Worms (DE); Holger Faeth, Fussgoenheim (DE); Markus Heldmann, Freudenberg (DE); Stefan Krauss, Gruenstadt (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/919,812

(22) PCT Filed: Nov. 11, 2008
(86) PCT No.: PCT/EP08/65291

§ 371 Date: Sep. 20, 2010

(30) Foreign Application Priority Data
Feb. 27, 2008 (DE) 10 2008 011 416.2

(51) Int. Cl. F02D 23/00

(52) U.S. Cl. 60/602

(57) ABSTRACT

A turbocharger has a wastegate duct that can be opened and closed by way of an actuator. The actuator encompasses a closing element that can be pivoted into the wastegate duct to close the same. This allows the required closing force, and hence also the size of the required actuator, to be reduced.

The invention relates to a turbocharger having an actuating device for opening and closing a wastegate duct.

Opening and closing of the wastegate, the bypass valve of the turbine of an exhaust-gas turbocharger, is effected by means of a flap that is controlled by a pneumatic actuator. Control by means of a pneumatic actuator entails several drawbacks. These are for example fluttering of the flap in the exhaust gas stream shortly before opening of the flap and the associated shattering of the flap seat. Furthermore, by means of an excess pressure unit it is only possible to control if there is enough boost pressure.

For this reason, control is to be effected by means of an electric actuator. Because of the lower power density of the electric actuator in relation to the pressure unit, the previous size of the actuating sensor would however be markedly exceeded.

The previous closing kinematics of the wastegate flap with their high actuating torque result, in the case of control by means of an electric actuator, in high continuous energization and high energy absorption from a motor vehicle electrical system.

Above all because of the limited installation space in the engine compartment the previously mentioned lower power density is a problem, this further intensifying temperature problems as a result of self-heating of the electric actuator.

A compact package of the turbocharger cannot be realized for the previously known kinematics with a powerful electric actuator.

The object of the present invention is accordingly to provide an improved actuating device for opening and closing a wastegate duct of a turbocharger.

This object is achieved by a turbocharger having the features of claim 1.

Accordingly, according to the invention a turbocharger is provided, having a wastegate duct,
wherein the wastegate duct may be opened and closed by means of an actuating device,
wherein the actuating device comprises a closing element that is pivotable into the wastegate duct in order to close the wastegate duct.

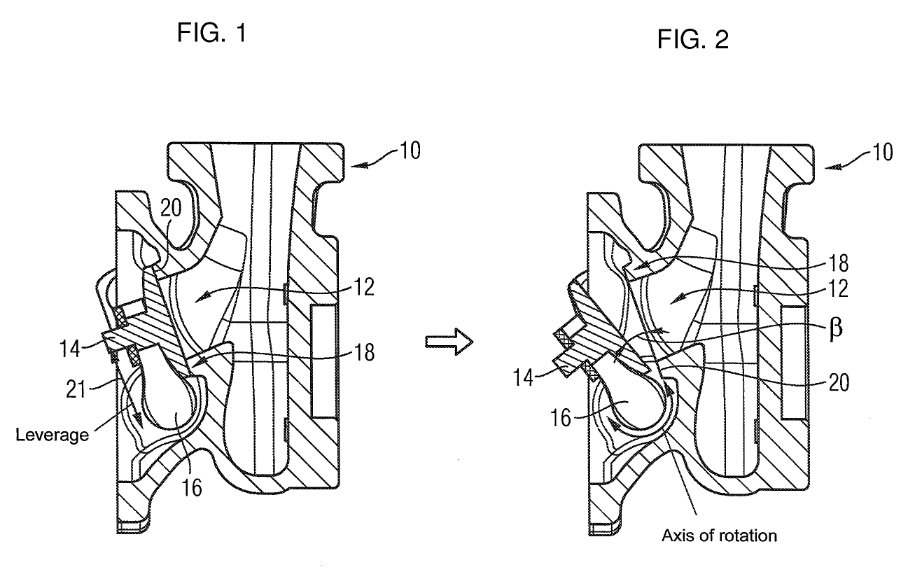

The turbocharger having the wastegate duct in this case has the advantage that by means of the inwardly pivotable closing element a smaller leverage of the closing kinematics may be achieved. This means that it is possible for example also to provide an electric actuator for actuating the actuating device and the closing element thereof. In the prior art, as will be described in detail below with reference to FIGS. 1 and 2, what occurs is merely a pivoting opening and shutting of the wastegate flap, not however a pivoting of the flap into the wastegate duct.

Advantageous refinements and developments of the invention arise from the sub-claims, as well as from the description with reference to the drawings.

In an embodiment according to the invention, the closing element at least in a region, in which it lies against a corresponding contact surface of the wastegate duct, is of a circular and/or spherical configuration or comprises a spherical segment. This has the advantage that pivoting into the wastegate duct is particularly easy.

In a further embodiment according to the invention, the longitudinal axis of the closing element extends substantially parallel to an axis that extends through the centre of the closing portion of the closing element, here the centre of the extended circular portion and/or the centre of the spherical segment of the closing element. This has the advantage that the closing operation of the closing element is effected by means of a rotational movement of the closing element into the wastegate duct. This means that for example the spherical segment during the closing operation does not simply rotate about an axis extending through the centre of the spherical segment. On the contrary, the centre of the spherical segment lies between a sealing surface and the axis of rotation. This has the effect that the closing operation is effected not only from a purely rotational movement but also by means of an axial relative movement in the direction of the sealing surface. This prevents the closing element from scraping along the contact surface and/or sealing surface of the wastegate duct.

According to a further embodiment according to the invention, the corresponding contact surface of the wastegate duct, against which the closing element lies in the closed state, is configured in such a way that the corresponding contact surface establishes for example substantially a line contact with the closing element when the closing element closes the wastegate duct. In principle, however, a surface contact is also possible. The line contact has the advantage that a better sealing effect may be achieved.

In another embodiment according to the invention, the actuating device comprises an arm, which is connected to the closing element and by means of which the closing element is pivotable into an open and closed position, in which the wastegate duct is fully closed. The longitudinal axis of the closing element may in this case be spaced apart from the axis of rotation of the arm and/or the longitudinal axis of the closing element may be configured inclined at an angle relative to a vertical through the fulcrum of the arm. Thus, the closing element has only a small leverage, compared to the leverage of a wastegate flap. This means that the actuating force for the closing element may likewise be markedly reduced.

In a further embodiment according to the invention, the longitudinal axis of the closing element intersects the axis of rotation of the arm and/or extends through the fulcrum of the arm. As a result, the lever arm may be reduced substantially even to zero.

In another embodiment according to the invention, the arm is of an angled configuration. In this case, the arm may have for example a portion bent through 90°, to which for example the closing element is fastenable. The bent portion of the arm for this purpose has for example a receiver for the closing element. The receiver for the closing element is for example configured in such a way that the closing element with its longitudinal axis is inclined relative to a vertical of the fulcrum of the arm or lies on the vertical of the fulcrum of the arm. In this way it is possible to realize a small leverage that may be substantially as low as zero.

According to a further embodiment according to the invention, the arm takes the form of a continuous shaft. In this case, the closing element may be fastened in such a way to the shaft that the longitudinal axis of the closing element intersects the axis of rotation of the shaft or is alternatively spaced apart therefrom, in a comparable manner to the angled portion. In this way it is likewise possible to realize a small leverage that may be reduced substantially down to zero.

In another embodiment according to the invention, at least one electric actuator and/or a pressure unit may be used to actuate the actuating device. An electric actuator is more suitable with the closing kinematics according to the invention than with the known wastegate flaps. Furthermore, in the case of the closing kinematics according to the invention the size of the pressure unit may be reduced.

There now follows a detailed description of the invention with reference to the embodiments that are indicated in the diagrammatic figures of the drawings. These show:

FIG. 1 a sectional view of part of a turbine housing and its wastegate duct, wherein the wastegate duct is closed by means of a wastegate flap according to prior art;

FIG. 2 the sectional view according to FIG. 1, wherein the wastegate flap according to prior art opens the wastegate duct;

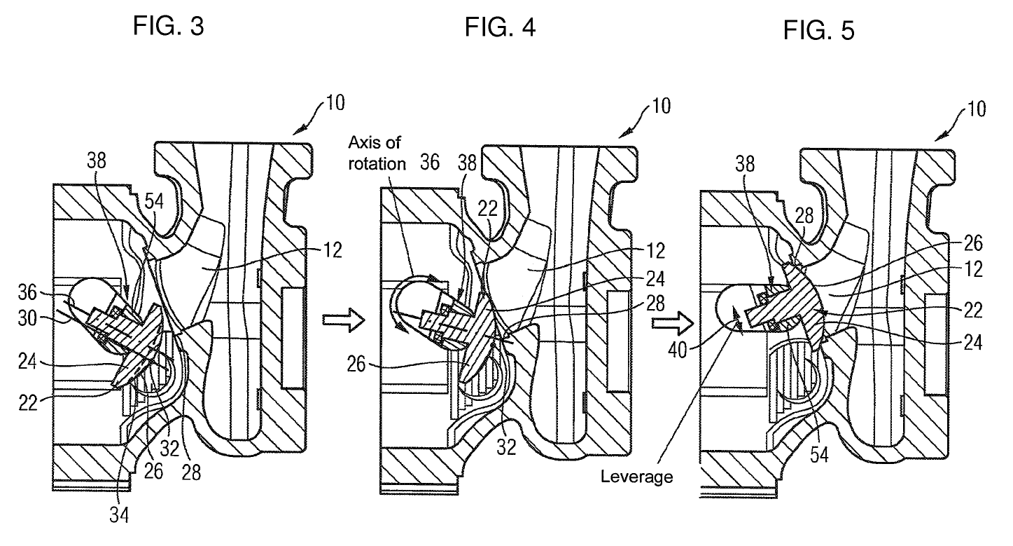

FIG. 3 a sectional view of a turbine housing and its wastegate duct, which is opened by means of an actuating device according to a first embodiment according to the invention;

FIG. 4 the sectional view according to FIG. 3, wherein the actuating device starts to close the wastegate duct;

FIG. 5 the sectional view according to FIGS. 3 and 4, wherein the wastegate duct is fully closed by means of the actuating device;

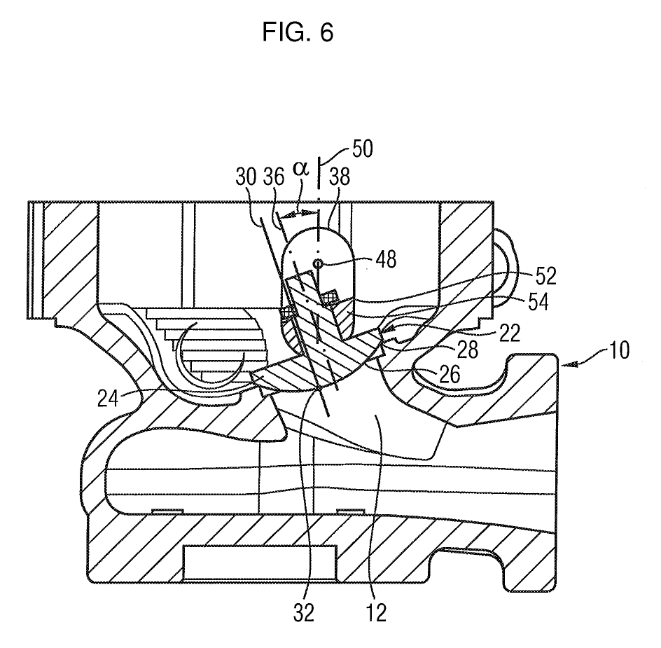

FIG. 6 a further sectional view of the turbine housing and its wastegate duct, which is closed by means of the actuating device according to the first embodiment according to the invention;

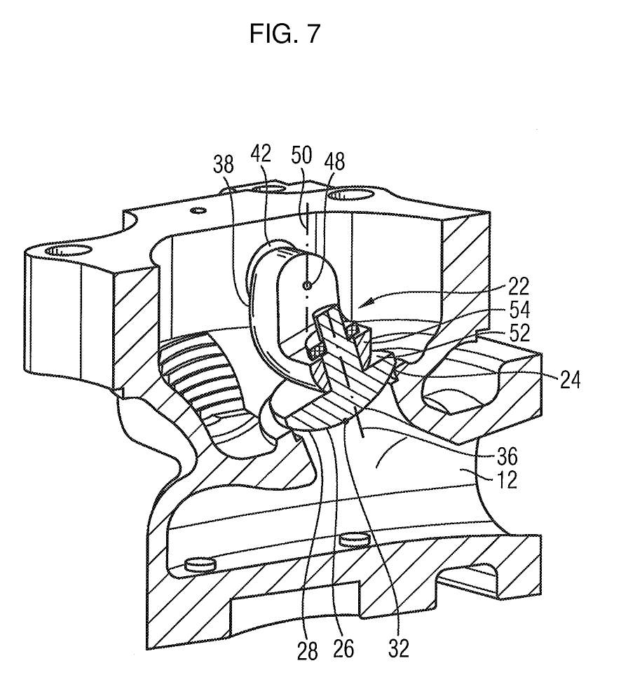

FIG. 7 a perspective view of the sectional view according to FIG. 6;

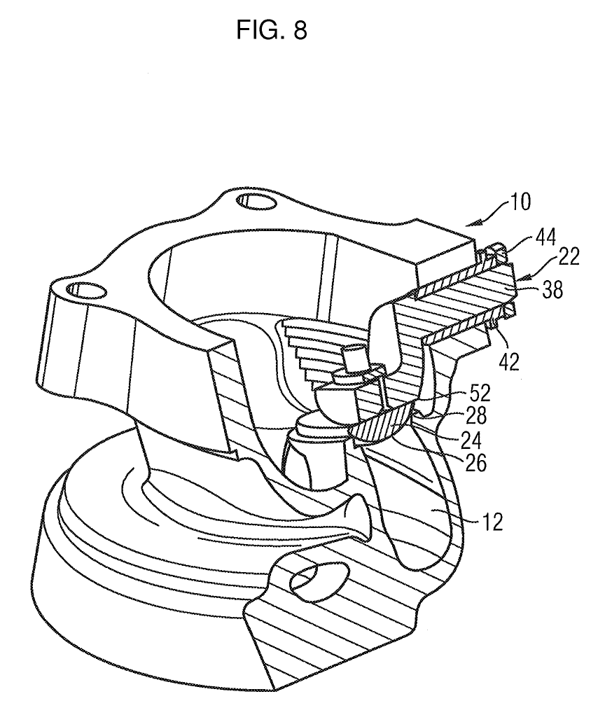

FIG. 8 a further perspective view of the sectional view according to FIG. 6 seen obliquely from the side;

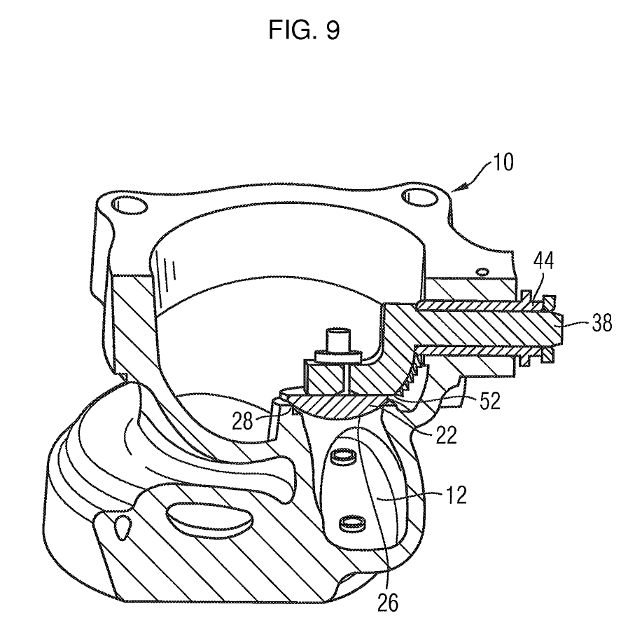

FIG. 9 a further perspective view of the sectional view according to FIG. 6 seen from the side;

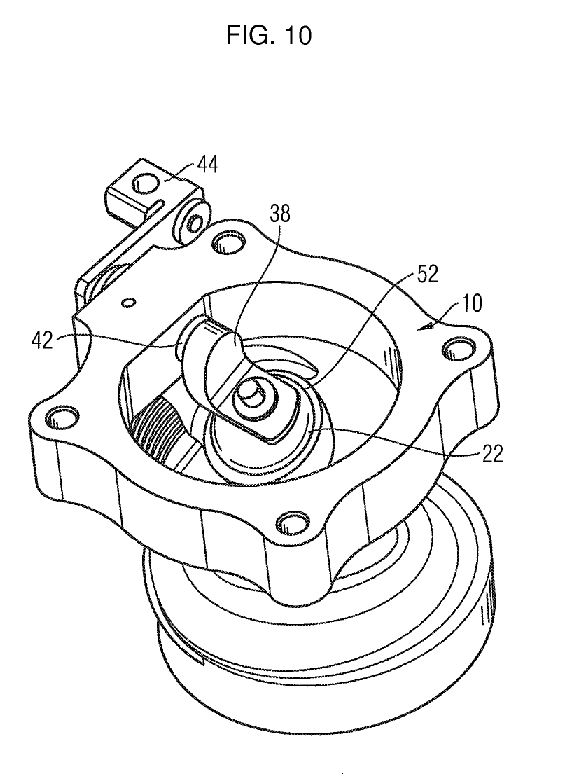

FIG. 10 a perspective view of the turbine housing and the actuating device seen from the rear;

FIG. 11 a sectional view of a turbine housing and its wastegate duct, which is opened by means of an actuating device according to a second embodiment according to the invention;

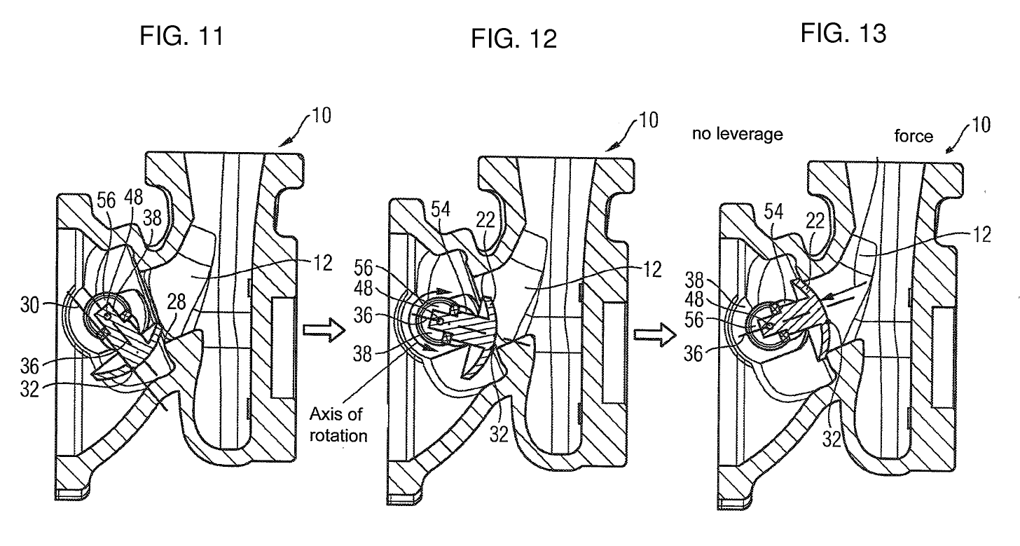

FIG. 12 the sectional view according to FIG. 11, wherein the actuating device starts to close the wastegate duct; and

FIG. 13 the sectional view according to FIGS. 11 and 12, wherein the wastegate duct is fully closed by means of the actuating device.

In all of the figures—unless indicated otherwise—identical and/or functionally identical elements and devices have been provided with the same reference characters.

FIG. 1 first shows a sectional view of part of a turbine housing 10 and its wastegate duct 12, wherein the wastegate duct 12 is closed by means of a wastegate flap 14 according to prior art.

In this case, the wastegate flap 14 is fastened to a lever element 16. By rotating the lever element 16 the wastegate flap 14 is deflected and/or pivoted. Here, by means of the angle of rotation β of the wastegate flap 14 various opening cross sections of the wastegate duct 12 may be achieved and hence the boost pressure may be controlled. Provided between the wastegate duct 12 and the wastegate flap 14 in the closed state is a “face-to-face” seal. This means that in a closed state the wastegate flap 14 lies with a surface against an end portion 18 of the wastegate duct 12 and seals off the wastegate duct 12. The wastegate flap 14 in this case has a planar and/or flat contact surface 20. This planar seal however has the drawback of not always producing an adequate sealing effect.

FIG. 2 shows the opening of the wastegate duct 12 by means of the wastegate flap 14. For this purpose the lever element 16, to which the wastegate flap 14 is fastened, pivots in an anticlockwise direction. In so doing, as already previously described, by means of the angle of rotation β of the wastegate flap 14 a respective suitable opening cross section of the wastegate duct 12 may be adjusted.

Such a wastegate flap 14 is normally activated by a pressure unit in order to open and close the wastegate duct 12. The force needed to close the wastegate duct 12 is however relatively high owing to the large leverage of the wastegate flap 14 and the moment resulting therefrom. An electric actuator for actuating the wastegate flap 14 and/or the lever element 16 thereof is therefore less suitable because the force it has to expend for this purpose is relatively high.

FIG. 3 now shows a sectional view of a turbine housing 10 and its wastegate duct 12, wherein the wastegate duct 12 is opened and closed, i.e. for example partially opened, fully opened and closed, in a manner comparable to that in the previously described prior art, by means of an actuating device 22 according to a first embodiment according to the invention.

The actuating device 22 in this case comprises a closing element 24. This closing element 24 comprises for example a spherical segment 26, which in a closed state of the wastegate duct 12 lies against a correspondingly conical contact surface 28 of the wastegate duct 12. In other words, the “face-to-face” seal of the prior art, as was described with reference to FIGS. 1 and 2, is replaced by a packing of the spherical segment 26 into the conical surface 28. The resulting sealing geometry is accordingly a circle, i.e. there is a line contact between the spherical closing element 24 and the conical contact surface 28 of the wastegate duct 12.

Closing is moreover effected by means of a rotational movement of the closing element 24 into the wastegate duct 12, as is shown in FIGS. 3, 4 and 5. In FIG. 3 the wastegate duct 12 is first opened by means of the closing element 24, the closing element 24 in this case being rotated out of the duct 12. In order to now close the wastegate duct 12, the closing element 24 is rotated in an anticlockwise direction in FIG. 4. The closing element 24 in this case moves gradually into the wastegate duct 12. In FIG. 5 the wastegate duct 12 is completely closed by means of the closing element 24. Here, the closing element 24 lies with its spherical segment 26 in line contact against the conical contact portion 28 of the wastegate duct 12.

In this case the spherical segment 26 of the closing element 24 during the closing operation does not rotate about an axis 30 extending through the centre of the spherical segment, rather the centre 32 of the spherical segment 26 lies between the sealing surface and the axis of rotation 36. For this reason, the closing operation results not only from a purely rotational movement but also from an axial relative movement in the direction of the sealing surface. Instead of the spherical segment 26 it is possible to provide merely a circular, circumferential portion 34 in the region, in which the closing element 24 lies against the contact surface 28 of the wastegate duct 12, as is indicated in FIG. 3 by a dashed line. In this case, the closing element 24 likewise does not rotate about the axis 30 extending through the centre 32 of the imaginary extension of the circular portion 34, rather the centre 32 here lies likewise, as in the case of the spherical segment 26, between sealing surface and axis of rotation 36.

This rotational movement and/or pivoting into the wastegate duct 12 is effected here, in the embodiment as represented in FIGS. 3 to 5, by an angled positioner and/or arm 38 in order in this way to be able to compensate tolerances and thermal expansion. This moreover prevents thermal expansion from causing constraining forces in the bearing arrangement or jamming of the closing element 24. A further advantage is that the leverage 40 of the actuating device 22 and of the closing element 24 thereof is smaller than the leverage 21 of the wastegate flap 14, as indicated in FIG. 1.

The embodiment in FIGS. 3 to 5 moreover has the advantage that a so-called fail-safe function may be guaranteed. This means that the actuating device 22 and/or its closing element 24 opens automatically if the pressure in the wastegate duct 12 becomes too high and/or if the wastegate duct 12 is unintentionally closed. By virtue of the fact that the actuating device 22 has a small leverage 40, this fail-safe function may be guaranteed.

The actuating device 22 and its closing element 24 according to the embodiment shown in FIGS. 3 to 5 are moreover described in detail with reference to FIGS. 6 to 10.

FIG. 6 now shows a sectional view through the turbine housing 10 and its wastegate duct 12, wherein the duct 12 is closed by means of the actuating device 22 and the closing element 26 thereof. FIGS. 7 to 9 further show various perspective part-sectional views of the turbine housing 10 and the actuating device 22 for opening and closing the wastegate duct 12. FIG. 10 moreover shows a perspective view of the actuating device 22 from the rear.

The closing element 24 in this case is fastened to an angled arm 38 of the actuating device 22, as is shown in FIGS. 6 to 10. The arm 38 here is mounted in a sleeve 42 in the turbine housing 10 (FIGS. 7-10) and rotated by means of an actuating element 44, as is shown in FIG. 10. This actuating element 44 may be part of an actuator, for example an electric actuator, or of a pressure unit or be suitably coupled thereto.

The longitudinal axis and/or axis of rotation 36 of the closing element 24 in this case does not extend through a fulcrum 48 and/or the axis of rotation of the arm but is spaced apart therefrom. In other words, the longitudinal axis and/or axis of rotation 36 of the closing element 24 does not lie on a vertical 50 through a fulcrum 48 of the arm 38, but is arranged inclined at an angle α relative to the vertical 50, as is indicated in FIG. 6.

As previously described, the leverage 40 of the closing element 24, as represented in FIGS. 5 and 6, is smaller the leverage 21 of the wastegate flap 14 in FIG. 1.

The arm 38, as it is represented for example in FIGS. 8, 9 and 10, need not necessarily be angled, here for example substantially at a right angle, any other angles also being conceivable. The crucial point is that the closing element 24 with its longitudinal axis and/or axis of rotation 36 does not intersect the axis of rotation of the arm 38 and/or extend through the fulcrum 48 thereof. The angled arm 38 in this case has on its angled portion 52 for example a suitable receiver 54, in which the closing element 24 may be arranged with its longitudinal axis and/or axis of rotation 36 inclined at an angle α relative to a vertical 50 of the axis of rotation of the arm 38.

FIGS. 11 to 13 show a second embodiment according to the invention of the actuating device 22. FIG. 11 shows a sectional view of the turbine housing 10 and the wastegate duct 12, wherein the wastegate duct 12 is opened by means of the actuating device 22 according to the second embodiment. In FIG. 12 the wastegate duct 12 is closed, the closing element 24 for this purpose being pivoted gradually into the wastegate duct 12. In FIG. 13 the wastegate duct 12 is fully closed by means of the closing element 24.

Unlike the first embodiment, the second embodiment of the actuating device 22 has a leverage of substantially zero. For this purpose, the axis of rotation and/or longitudinal axis 36 of the closing element 24 intersects the axis of rotation of the arm 38 and/or passes through the fulcrum 48 thereof. The result is a leverage of zero.

The closing element 24 of the second embodiment in this case, like the closing element 24 of the first embodiment, is configured with a spherical segment 26 that in a closed state of the wastegate duct 12 lies against the conical contact portion 28 of the wastegate duct 12 and with this forms a line contact in the form of a circle. As in the first embodiment, the spherical segment 26 in the second embodiment during the closing operation does not rotate about an axis 30 extending through the centre 32 of the spherical segment 26, rather the centre 32 of the spherical segment 26 lies between the sealing surface and the axis of rotation 30. For this reason, the closing operation results not only from a purely rotational movement but also from an axial relative movement in the direction of the sealing surface.

The actuating device 22 may, as in the first embodiment, comprise an arm, wherein the closing element 24 with its axis 36 extends through the fulcrum 48 of the arm and/or intersects the axis of rotation of the arm 38, in contrast to the first embodiment. The arm 38, instead of being of an angled configuration, as in the first embodiment (FIGS. 7-10), may moreover be configured in the form of a shaft 56, as shown in FIGS. 11-13, which at its other end is connected to the closing element 24. This is equally possible in the first embodiment.

In the second embodiment, the axis and/or longitudinal axis 36 of the closing element 24 intersects the axis of rotation of the shaft, as is represented in FIGS. 11 to 13, and/or the fulcrum 48 thereof.

By virtue of this change of the closing kinematics, as has been described above with reference to the two embodiments of the invention, the required closing force and hence also the dimensions of the required actuator may be reduced. As a result of the drastic reduction of the leverage 40 and hence the reduction of the actuating force, a more compact electric actuator may therefore be used, or the size of the pressure unit may be considerably reduced, for actuating the actuating device 22 and the closing element 24 thereof.

A further advantage lies in the fact that the opening characteristic resulting from the new kinematics is much better suited to an electric actuator than was previously the case with the wastegate flap solutions.

Although the present invention has been described above with reference to the preferred exemplary embodiments, it is not restricted thereto but may be modified in many ways. The previously described embodiments, in particular individual features thereof, may in this case be combined with one another.

In particular, the actuating device 22 and its connection to the closing element 24 may be of any desired configuration, besides an arm 38 other devices and arrangements may also be provided for inward pivoting of the closing element 24 in accordance with the closing kinematics according to the invention. Furthermore, the closing element 24 itself may also take other forms than the previously described forms of spherical segment 26 or circular and/or spherical portion 34.

The actuating device is moreover usable not only in a wastegate duct of a turbine housing but also in a wastegate for example for a compressor and/or to bypass a compressor, to cite merely one example.

1-13. (canceled)

14. A turbocharger with a wastegate duct, comprising:
an actuating device configured to selectively open and close the wastegate duct;
said actuating device including a closing element pivotally mounted for pivoting into the wastegate duct in order to close the wastegate duct.

15. The turbocharger according to claim 14, wherein the wastegate duct is formed with a contact surface and said closing element is formed to correspond to the contact surface.

16. The turbocharger according to claim 15, wherein said closing element, at least in a region in which said closing element lies against the contact surface, has a circular or spherical configuration, or is formed with a spherical segment.

17. The turbocharger according to claim 16, wherein said closing element has an axis extending at a predetermined distance parallel to an axis extending through a center of the extended circular portion and/or the center of said spherical segment of said closing element.

18. The turbocharger according to claim 14, wherein said closing element has an axis extending at a predetermined distance parallel to an axis extending through a center of an end portion of said closing element.

19. The turbocharger according to claim 14, wherein the wastegate duct is formed with a corresponding contact surface against which said closing element lies in a closed state, and the contact surface together with said closing element establish substantially a line contact when said closing element closes the wastegate duct.

20. The turbocharger according to claim 19, wherein the contact surface is conical and contacts said closing element along a substantially circular line contact when the wastegate duct is closed by said closing element.

21. The turbocharger according to claim 20, wherein said actuating device comprises an arm connected to said closing element and pivoting said closing element between an open position and a closed position, in which the wastegate duct is fully closed.

22. The turbocharger according to claim 21, wherein said closing element has an axis spaced apart from a pivot axis of said arm.

23. The turbocharger according to claim 21, wherein said arm has a fulcrum spaced apart from an axis through said closing element.

24. The turbocharger according to claim 21, wherein said closing element has an axis intersecting a pivot axis of said arm.

25. The turbocharger according to claim 21, wherein said arm has a fulcrum and an axis through said closing element intersects said fulcrum.

26. The turbocharger according to claim 21, wherein said arm is an angled arm with an angled portion bent through substantially 90°.

27. The turbocharger according to claim 26, wherein said angled portion of said arm has a receiver for said closing element.

28. The turbocharger according to claim 27, wherein said receiver for said closing element is configured such that said an axis of said closing element is inclined relative to a vertical of said fulcrum of said arm or coincides with the vertical of said fulcrum of said arm.

29. The turbocharger according to claim 21, wherein said arm is a continuous shaft having said closing element fastened thereto, and an axis of said closing element intersects an axis of rotation of said shaft.

30. The turbocharger according to claim 21, wherein said arm is a continuous shaft having said closing element fastened thereto, and an axis of said closing element is spaced from an axis of rotation of said shaft.

31. The turbocharger according to claim 14, wherein said actuating device is actuable by an actuator selected from the group consisting of at least one electric actuator and a pressure unit.
